(19) United States
(12) Patent Application Publication
(10) Pub. No.: US 2019/0317328 A1
(43) Pub. Date: Oct. 17, 2019

(54) SYSTEM AND METHOD FOR PROVIDING AUGMENTED-REALITY ASSISTANCE FOR VEHICULAR NAVIGATION

(71) Applicant: Faraday&Future Inc., Gardena, CA (US)

(72) Inventor: Hong S. BAE, Torrance, CA (US)

(21) Appl. No.: 15/955,338

(22) Filed: Apr. 17, 2018

(51) Int. Cl. G02B 27/01; G06T 19/00; G01C 21/36; G06K 9/00

(52) U.S. Cl. CPC G02B 27/017; G06T 19/006; G01C 21/365; G02B 2027/0183; G02B 2027/0178; G02B 2027/0181; G02B 2027/0185; G06K 9/00791

(57) ABSTRACT

The disclosure is related to a set of augmented reality (AR) driving glasses for use during operation of a vehicle, such as consumer automobile. In some embodiments, the AR driving glasses display one or more images related to vehicle operation, such as navigation images, hazard images, vehicle settings images, and other images. The images are generated based on data collected by one or more sensors of the vehicle (e.g., cameras, GPS, LIDAR, range sensors, ultrasonic sensors, etc.) and/or by one or more sensors included in the AR driving glasses (e.g., cameras, ambient light sensors, motion sensors, biometric sensors, etc.). The images are sized and displayed at a location on the display in accordance with at least data from one or more sensors of the AR driving glasses (e.g., motion data or camera data) and/or data from the vehicle (e.g., vehicle speed).

### FIELD OF THE DISCLOSURE

This relates generally to augmented reality (AR) and more specifically to a set of AR driving glasses designed for use in a vehicle.

### BACKGROUND OF THE DISCLOSURE

Vehicles, especially automobiles, increasingly include display heads up displays (HUDs) for displaying information at a location closer to the driver's line of sight than, for example, typical instrument clusters and dashboards. In some examples, HUDs are incorporated into the front windshield of the vehicle. HUDs can display information of use to the driver, such as vehicle speed, navigation directions, notifications, and other information. However, due to the relatively high cost of HUDs, the size of current HUDs is small, limiting their full potential. For example, HUDs can be limited to a small portion of the windshield, which prevents the display of information at locations on the windshield that do not include the HUD.

### SUMMARY OF THE INVENTION

The present invention is directed to augmented reality (AR) driving methods and systems, such as glasses for use in a vehicle. In some embodiments, the AR driving glasses include one or more lenses having displays included therein. The displays display one or more images related to operation of the vehicle, such as indications of hazards, navigation directions, and/or information about the vehicle. The AR driving glasses receive information from the vehicle for generating the displayed images. Wired or wireless communication are possible. Wireless AR driving glasses include rechargeable batteries to provide power while in use. Power cables are also possible for wired configurations. The size and location of the image are adjusted by the AR driving glasses based on data from one or more sensors (e.g., gyroscopes and/or cameras) included in the AR driving glasses and/or data from the vehicle (e.g., speedometer data). In accordance with certain embodiments, the lenses further include variable focal points allowing for wearers that use corrective lenses to use the AR driving glasses without their corrective eyewear. In some embodiments, the AR driving glasses include an iris scanner for identifying a user and updating one or more settings, such as focal point, in accordance with the identity of the user of the AR driving glasses. The AR driving glasses further include variable darkness of the lenses (i.e., electrochromic material within the lenses).

### BRIEF DESCRIPTION OF THE DRAWINGS

FIG. 1 illustrates a system block diagram of a vehicle control system according to examples of the disclosure.

FIG. 2 illustrates a system block diagram of augmented reality (AR) driving glasses according to examples of the disclosure.

FIG. 3 illustrates exemplary AR driving glasses.

FIG. 4 illustrates exemplary AR driving glasses in a wireless configuration.

FIG. 5 illustrates exemplary AR driving glasses in a wired configuration.

FIG. 6A illustrates exemplary AR driving glasses displaying a warning image and a navigation image.

FIG. 6B illustrates exemplary AR driving glasses displaying warning images.

FIG. 7 illustrates an exemplary process for operating AR driving glasses.

### DESCRIPTION OF PREFERRED EMBODIMENTS

In the following description, references are made to the accompanying drawings that form a part hereof, and in which it is shown by way of illustration specific examples that can be practiced. It is to be understood that other examples can be used and structural changes can be made without departing from the scope of the disclosed examples. Further, in the context of this disclosure, “autonomous driving” (or the like) can refer to autonomous driving, partially autonomous driving, and/or driver assistance systems.

The present invention is directed to augmented reality (AR) driving methods and systems, such as glasses for use in a vehicle. In some embodiments, the AR driving glasses include one or more lenses having displays included therein. The displays display one or more images related to operation of the vehicle, such as indications of hazards, navigation directions, and/or information about the vehicle. The AR driving glasses receive information from the vehicle for generating the displayed images. Wired or wireless communication are possible. Wireless AR driving glasses include rechargeable batteries to provide power while in use. Power cables are also possible for wired configurations. The size and location of the image are adjusted by the AR driving glasses based on data from one or more sensors (e.g., gyroscopes and/or cameras) included in the AR driving glasses and/or data from the vehicle (e.g., speedometer data). In accordance with certain embodiments, the lenses further include variable focal points allowing for wearers that use corrective lenses to use the AR driving glasses without their corrective eyewear. In some embodiments, the AR driving glasses include an iris scanner for identifying a user and updating one or more settings, such as focal point, in accordance with the identity of the user of the AR driving glasses. The AR driving glasses further include variable darkness of the lenses (i.e., electrochromic material within the lenses).

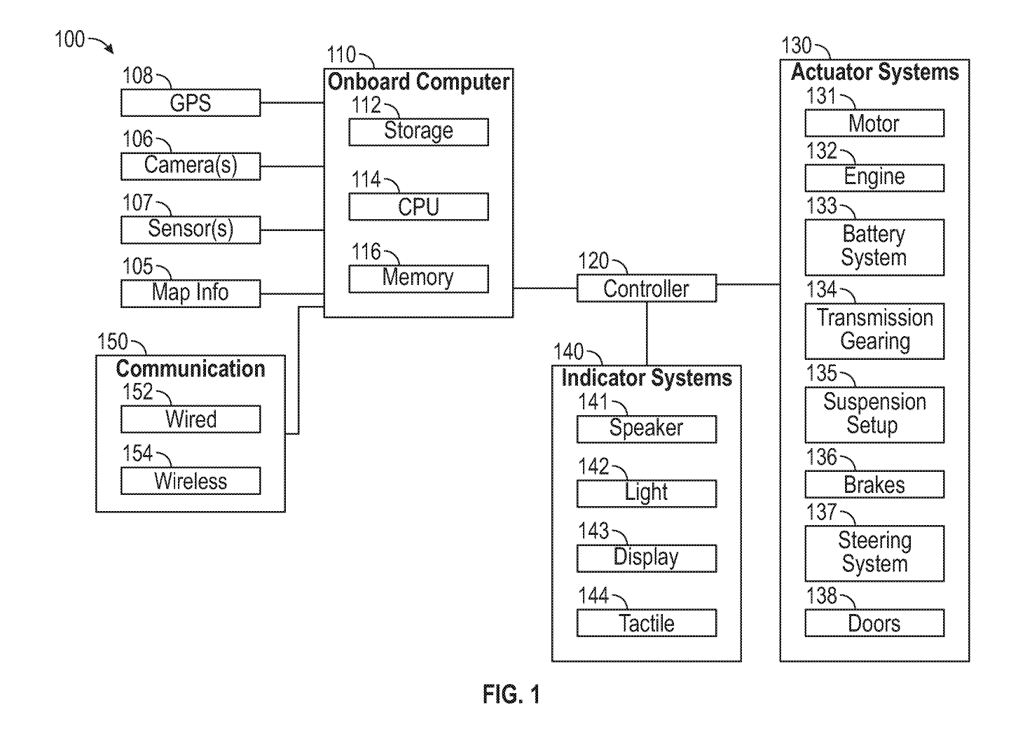

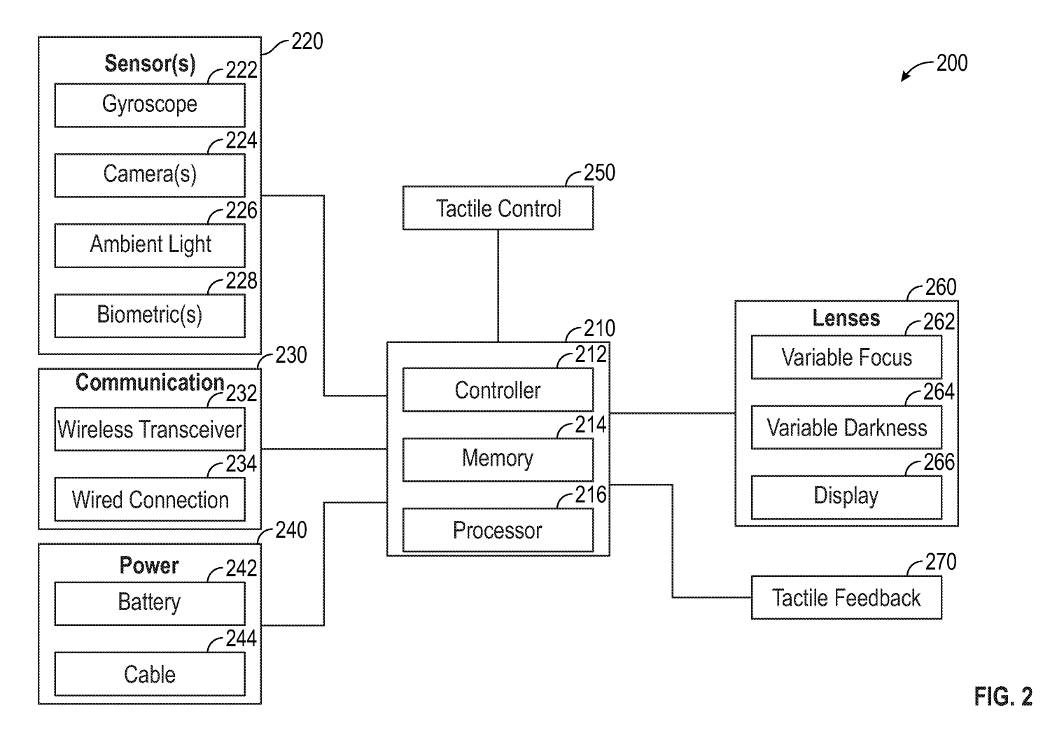

FIG. 1 illustrates a system block diagram of vehicle control system 100 according to examples of the disclosure. Vehicle control system 100 can perform any of the methods described with reference to FIGS. 2-7 below. System 100 can be incorporated into a vehicle, such as a consumer automobile. Other example vehicles that may incorporate the system 100 include, without limitation, airplanes, boats, or industrial automobiles. In some embodiments, vehicle control system 100 includes one or more cameras 106 capable of capturing image data (e.g., video data) for determining various features of the vehicle's surroundings. Vehicle control system 100 can also include one or more other sensors 107 (e.g., radar, ultrasonic, LIDAR, IMU, suspension level sensor, etc.) capable of detecting various features of the vehicle's surroundings, and a Global Navigation Satellite System (GNSS) receiver 108 capable of determining the location of the vehicle. It should be appreciated that GNSS receiver 108 can be a Global Positioning System (GPS) receiver, BeiDou receiver, Galileo receiver, and/or a GLONASS receiver. Vehicle control system 100 can receive (e.g., via an internet connection) feature map information via a map information interface 105 (e.g., a cellular internet interface, a Wi-Fi internet interface, etc.). In some examples, vehicle control system 100 can further include a communication system 150 configured for sending information to and receiving information from augmented reality (AR) driving glasses. The communication system 150 can include one or more of a wired communication interface 152 and a wireless communication interface 153. In some embodiments, the wired communication interface 152 includes a port for connecting the AR driving glasses to the vehicle by way of a cable or other wired connection. The wireless communication interface 154 includes a transceiver for communicating with the AR driving glasses via a wireless protocol.

Vehicle control system 100 further includes an on-board computer 110 that is coupled to the cameras 106, sensors 107, GNSS receiver 108, map information interface 105, and communication system 150 and that is capable of receiving outputs from the sensors 107, the GNSS receiver 108, map information interface 105, and communication system 150. The on-board computer 110 is capable of transmitting information to the AR driving glasses to cause the AR driving glasses to display one or more images, generate one or more tactile alerts, change lens tint, and/or change lens focus. Additional functions of the AR glasses controlled by the on-board computer 110 are possible and are contemplated within the possession of this invention. On-board computer 110 includes one or more of storage 112, memory 116, and a processor 114. Processor 114 can perform the methods described below with reference to FIGS. 2-7. Additionally, storage 112 and/or memory 116 can store data and instructions for performing the methods described with reference to FIGS. 2-7. Storage 112 and/or memory 116 can be any non-transitory computer readable storage medium, such as a solid-state drive or a hard disk drive, among other options that are known in the art.

In some embodiments, the vehicle control system 100 is connected to (e.g., via controller 120) one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137 and door system 138. The vehicle control system 100 controls, via controller 120, one or more of these actuator systems 130 during vehicle operation; for example, to control the vehicle during fully or partially autonomous driving operations, using the motor 131 or engine 132, battery system 133, transmission gearing 134, suspension setup 135, brakes 136 and/or steering system 137, etc. Actuator systems 130 can also include sensors that send dead reckoning information (e.g., steering information, speed information, etc.) to on-board computer 110 (e.g., via controller 120) to determine the vehicle's location and orientation. The one or more indicator systems 140 can include, but are not limited to, one or more speakers 141 in the vehicle (e.g., as part of an entertainment system in the vehicle), one or more lights 142 in the vehicle, one or more displays 143 in the vehicle (e.g., as part of a control or entertainment system in the vehicle) and one or more tactile actuators 144 in the vehicle (e.g., as part of a steering wheel or seat in the vehicle). The vehicle control system 100 controls, via controller 120, one or more of these indicator systems 140 to provide visual and/or audio indications, such as an indication that a driver will need to take control of the vehicle, for example.

FIG. 2 illustrates a system block diagram 200 of augmented reality (AR) driving glasses according to examples of the disclosure. System 200 includes computer 210, one or more sensors 220, one or more communication systems 230, one or more power systems 240, a button 250, one or more lenses 260, and optionally includes tactile feedback 270. System 200 can perform any of the methods described with reference to FIGS. 2-7 below.

In some embodiments, system 200 includes one or more sensors 220. The sensors 220 can include one or more gyroscopes 222, one or more cameras 224, an ambient light sensor 226, and/or one or more biometric sensors 228. Additional sensors are possible. Gyroscopes 222 sense the position and movement of the AR driving glasses incorporating system 200. In some embodiments, the gyroscope 222 data are used to determine the location of one or more images displayed by system 200. Cameras 224 can include cameras directed in the direction the wearer of the glasses is looking and/or at the eyes of the wearer of the glasses. Cameras 224 can capture images of the surroundings of system 200 to determine which images to display. Images captured of the wearer of the glasses can be used to detect where the wearer is looking for the purpose of modifying the location of one or more displayed images. Cameras 224 can also be used to detect a level of ambient light to control the darkness of the glasses. Additionally or alternatively, system 200 includes an ambient light sensor 226 separate from the cameras 224 for determining the level of ambient light. In some embodiments, system 200 includes one or more biometric sensors 228 (e.g., an iris scanner) for identifying the wearer of the glasses. System 200 can personalize one or more settings of the glasses, such as variable focus 262 or other features, based on the identity of the wearer of the glasses. In some embodiments, biometric sensors 228 are used to authenticate an authorized driver/user of the vehicle. When the wearer of the AR driving glasses is determined to be an authorized user of the vehicle, the AR glasses display (e.g., on display 266) an image confirming successful authentication. Optionally, successful authentication can cause the vehicle to power on, unlock, or provide some other level of vehicle access. When the wearer of the AR driving glasses is determined not to be an authorized user of the vehicle, the AR glasses display (e.g., on display 266) an image confirming authentication failure (e.g., access denied). Optionally, failed authentication can cause the vehicle to power off, lock, or deny some other level of vehicle access. In some embodiments, other sensors are possible.

System 200 further includes one or more communication systems 230. Communication systems 230 can be used to communicate with the vehicle (e.g., a vehicle incorporating system 100) the wearer is driving or riding in and/or one or more electronic devices within the vehicle (e.g., a smartphone, tablet, or other consumer electronic device). In some embodiments, system 200 includes a wireless transceiver 232 configured to communicate using a wireless connection (e.g., Bluetooth, cellular, Wi-Fi, or some other wireless protocol). Additionally or alternatively, system 200 includes a wired connection 234 to one or more other systems with which it communicates. The AR driving glasses can send information such as sensor data 220, button 250 status and/or other information using communication systems 230. Communication systems 230 can receive information such as sensor data from other devices, images for display by the AR driving glasses, alerts, and/or other information.

System 200 further includes one or more power systems 240. In some embodiments, system 200 includes a battery 242, which can be a rechargeable battery or a single-use battery. Additionally or alternatively, the power systems 240 include a power cable 244 that can recharge a rechargeable battery 242 or directly power system 200.

System 200 optionally includes tactile control 250. Tactile control 250 can include one or more of a tab, button, switch, knob, dial, or other control feature operable by the wearer of the AR driving glasses. In some embodiments, the tactile control 250 can be used to answer a phone call transmitted to a vehicle (e.g., by way of a mobile phone) in communication with the AR driving glasses. For example, operating the tactile control can cause a call to be answered or terminated. Tactile control 250 can optionally function to dismiss one or more alerts communicated by the AR driving glasses. Other uses of tactile control 250 are possible.

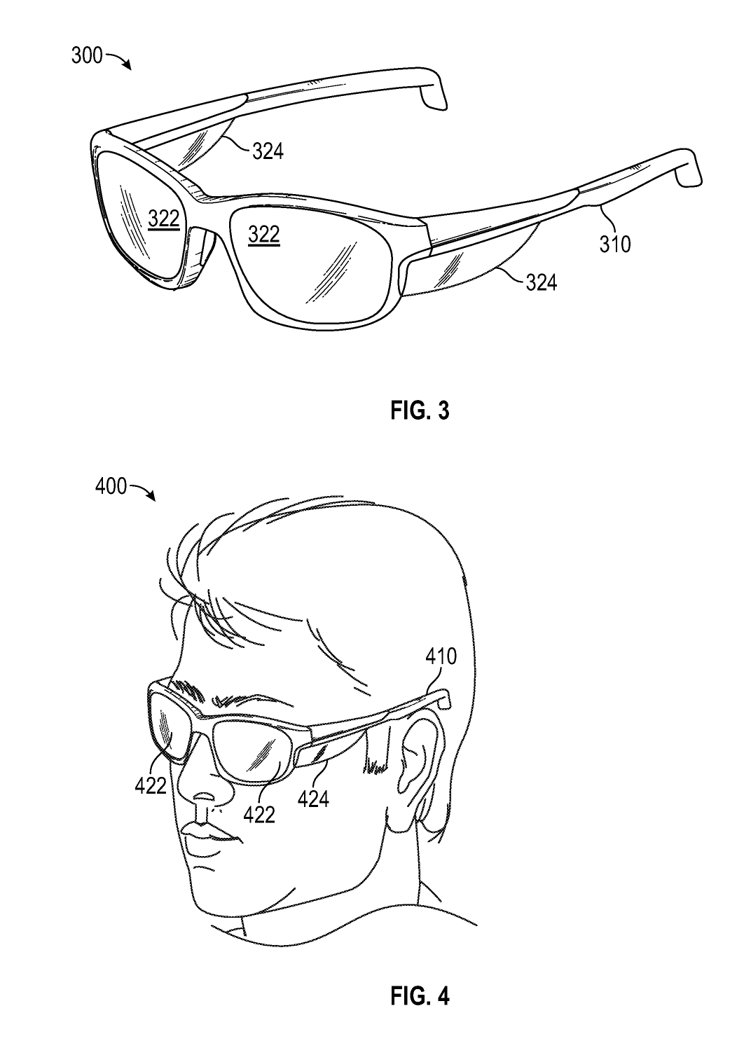

System 200 further includes a plurality of lenses 260 of the AR driving glasses. Lenses 260 can include one or more lenses in front of the wearer's eyes and/or in the wearer's periphery, as will be illustrated below in FIGS. 3-7. In some embodiments, one or more of the lenses 260 can have a variable focus 262 (i.e., a variable focal point) that can be modified by the wearer and/or modified automatically based on identifying the wearer (e.g., using a biometric sensor 228). Variable focus 262 can include one or more of an electro-optical system such as liquid crystals with variable alignment and/or electro-mechanical systems such as flexible lenses or liquid pressure lenses. Variable focus 262 lenses allow wearers who use prescription eyewear to wear the AR driving glasses without their prescription eyewear, for example. In some embodiments, system 200 further includes variable darkness 264 lenses. Variable darkness 264 can be achieved using electrochromic lens material, for example. In some embodiments, the lenses 260 can darken automatically based on data collected from the cameras 224 and/or ambient light sensor 226. Lenses 260 further include displays 266 for displaying one or more AR images. Displays 266 can be transparent LEDs embedded in the lens 260 material and/or a projector system with the projector mounted on the AR driving glasses frame. In some embodiments, images for display are generated by computer 210. Additionally or alternatively, images for display can be received through communication system 230.

System 200 optionally includes tactile feedback 270. In some embodiments, the AR driving glasses can include a vibrating mechanism that generates vibrations in association with one or more alerts displayed using display 266 or played using a speaker system of the vehicle (e.g., speaker 141). For example, tactile feedback 270 alerts the wearer when the vehicle is in a dangerous situation (e.g., a hazard is detected). In some embodiments, system 200 includes multiple tactile feedback mechanisms 270, allowing the AR driving glasses to produce directional tactile feedback. For example, when there is a hazard to the left of the vehicle, a tactile feedback mechanism 270 on the left side of AR driving glasses provides tactile feedback to the user.

In some embodiments, system 200 includes computer 210. Computer 210 includes one or more controllers 212, memory 214, and one or more processors 216. Computer 210 controls one or more operations executed by systems of the AR driving glasses.

FIG. 3 illustrates exemplary AR driving glasses 300. The AR driving glasses 300 include front lenses 322 and side lenses 324 mounted to frame 310. Front lenses 322 are located in front of the wearer's eyes and side lenses 324 are located in at the periphery of the wearer's eye when AR driving glasses 300 are being worn. AR driving glasses 300 can incorporate one or more components of system 200 described with reference to FIG. 2. Frame 310 can house one or more sensors 220, communication systems 230, power systems 240, tactile control device 250, computer 210, and tactile feedback system 270. Lenses 322 and 324 correspond to lenses 260 and can include one or more of variable focus 262, variable darkness 264, and a display 266.

During operation, AR driving glasses 300 can present information to the wearer in the form of images and/or tactile feedback. In some embodiments, the AR driving glasses 300 receive data from the vehicle to control the information presented to the wearer, such as navigation information, hazard alerts, and other information that the computer 210 of the AR driving glasses can use to generate one or more images to be displayed on the lenses 322 and/or 324. In some embodiments, the vehicle generates and transmits the images to the AR driving glasses 300 to display. The location and size of the displayed images can be determined based on the vehicle's speed and surroundings, the wearer's head position, where the wearer is looking, and other factors.

FIG. 4 illustrates exemplary AR driving glasses 400 in a wireless configuration. AR driving glasses 400 can incorporate one or more components of system 200 described with reference to FIG. 2 and/or one or more components of AR driving glasses 300 described with reference to FIG. 3, such as front lenses 422, side lenses 424, and frame 410. Front lenses 422 are located in front of the wearer's eyes and side lenses 424 are located in at the periphery of the wearer's eye when AR driving glasses 400 are being worn. AR driving glasses 400 include a rechargeable battery (e.g., battery 242) and a wireless transceiver (e.g., wireless transceiver 232), thereby enabling wireless operation of the glasses. As described above with reference to FIGS. 2-3, the AR driving glasses 400 receive information from the vehicle, such as one or more images or data for use in creating one or more images, by way of the wireless connection. A battery powers the AR driving glasses 400, allowing for fully wireless operation. While not in use, the glasses can be recharged using a power cable coupled to a power source in the vehicle or outside of the vehicle.

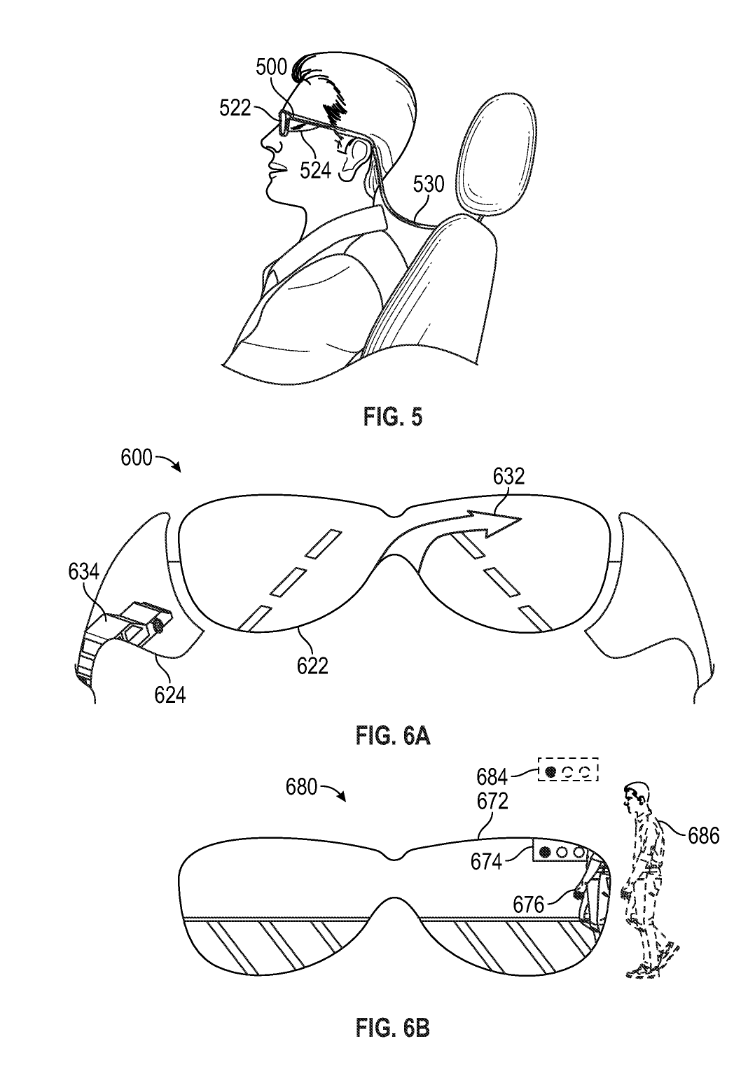

FIG. 5 illustrates exemplary AR driving glasses 500 in a wired configuration. AR driving glasses 500 can incorporate one or more components of system 200 described with reference to FIG. 2 and/or one or more components of AR driving glasses 300 described with reference to FIG. 3, such as front lenses 522, side lenses 524, and frame 510. Front lenses 522 are located in front of the wearer's eyes and side lenses 524 are located in at the periphery of the wearer's eye when AR driving glasses 500 are being worn. AR driving glasses 500 include a cable 530 coupled to the vehicle via connection to the vehicle seat. Other connection points within the vehicle, such as a connection point on the vehicle's ceiling, are possible. Cable 530 is used for communication with the vehicle and/or to power the AR driving glasses 500. Because the AR driving glasses 500 include vehicle-specific functions, a wired configuration can reduce the cost and/or weight of the AR driving glasses 500 without sacrificing functionality, as the AR driving glasses do not need to be removed from the vehicle. In some embodiments, AR driving glasses 500 include a battery (e.g., battery 242) and the cable 510 is used for communication. In some embodiments, AR driving glasses 500 include a transceiver (e.g., transceiver 232) and the cable 510 is used for power.

FIG. 6A illustrates exemplary AR driving glasses 600 displaying a warning image 634 and a navigation image 632. AR driving glasses 600 can correspond to one or more of AR driving glasses 300, 400, or 500 and can include one or more components of system 200. As an example, during use, the front lens(es) 622 display a navigation image 632 while one of the side lenses 624 displays a warning image 634.

In some embodiments, navigation image 632 is associated with navigation directions provided by the vehicle and/or a mobile device operatively coupled to the vehicle and/or to the AR driving glasses 600. As shown in FIG. 6A, the navigation image 632 includes an arrow indicating where the driver should turn the vehicle to follow the navigation directions. The placement and/or size of the navigation image 632 is determined so that the arrow looks like it is displayed on the ground at the location the turn is to be executed. One or more sensors 220 within AR driving glasses 600 collect data used to determine image size and location to create this effect. Additionally, the AR driving glasses 600 can receive information from the vehicle, such as vehicle speed. One or more gyroscopes 222 of the AR driving glasses 600 determine the orientation of the user's head, one or more outward-facing cameras or other sensors determine the AR driving glasses 600 location relative to the vehicle (e.g., due to an unknown height of the user) and the location on the road where the image is supposed to appear, and one or more inward-facing cameras of the AR driving glasses 600 determine where the user is looking. With this information and with information from the vehicle (e.g., vehicle speed), the desired location on the lens 622 and size for the image 632 to be displayed is determined. In some embodiments, the AR driving glasses 600 optionally generate tactile feedback 270 to notify the user of the navigation image 632.

In some embodiments, warning image 634 is associated with a driver assistance system of the vehicle. As shown in FIG. 6A, the warning image 634 includes an indication of a vehicle driving next to the vehicle the wearer is driving or riding in. In some embodiments, the location of the vehicle depicted in warning image 634 is detected by a side camera of the vehicle. The placement and/or size of the warning image 634 is determined to convey the location of the other vehicle (e.g., determined by the side camera of the vehicle) while at the same time being visible to the user. For example, while the wearer is looking forward, the warning image 634 is displayed on the side of the AR driving glasses 600 that corresponds to the other vehicle's location. AR driving glasses 600 use sensors included in the AR driving glasses (e.g., gyroscopes and cameras) and/or data received from the vehicle (e.g., vehicle speed) as described above to refine the placement of the warning image 634. The warning image 634 is generated in response to the vehicle detecting the other vehicle using cameras 106 and/or sensors 107 (e.g., LIDAR, ultrasonics, range sensors, etc.). In some embodiments, the AR driving glasses 600 optionally generate tactile feedback 270 to notify the user of the warning image 634.

There are a number of different ways that navigation image 632 and/or warning image 634 can be generated by the system. In some embodiments, the vehicle and/or mobile device transmits to the AR driving glasses 600 information about the navigation instructions (e.g., that a right turn is the next direction) or about the other vehicle (e.g., the location of the other vehicle) and the computer 210 on the AR driving glasses 600 generates the images 632 and/or 634 using that information. In this way, the amount of data being transmitted between the AR driving glasses 600 and the vehicle and/or mobile device is relatively small while the amount of processing performed by the AR driving glasses is relatively large. In some embodiments, the AR driving glasses 600 transmit the sensor data for sizing and positioning one or more of the images 632 and 634 to the vehicle and/or mobile device and receive the navigation image 632 and/or warning image 634 to be displayed. In this way, the amount of data being transmitted between the AR driving glasses 600 and the vehicle and/or mobile device is relatively large while the amount of processing performed by the AR driving glasses is relatively small.

FIG. 6B illustrates exemplary AR driving glasses 680 displaying warning images 674 and 676. AR driving glasses 680 can correspond to one or more of AR driving glasses 300, 400, 500, or 600 and can include one or more components of system 200.Warning image 676 indicates the presence of pedestrian 686 while warning image 674 indicates the presence of a red traffic light 684. Warning images 674 and 676 are generated in any of the ways described above with reference to warning image 634. In some embodiments, the AR driving glasses 680 optionally generate tactile feedback 270 when displaying one or more of warning images 674 and 676. Red traffic light 684 can be detected by the vehicle's camera(s) 106 and/or the vehicle can be informed of the red light via one or more of its communication modules 150 (e.g., a smart traffic light can transmit a signal indicating that it is a red light and/or one or more other vehicles can transmit information to the vehicle about the status of the traffic light). The pedestrian 686 can be detected by the vehicle's camera(s) 106 and/or sensor(s) (e.g., LIDAR, ultrasonics, range sensors, etc.). In response to detecting the red light 684 and the pedestrian 686, AR driving glasses 680 display the warning images.

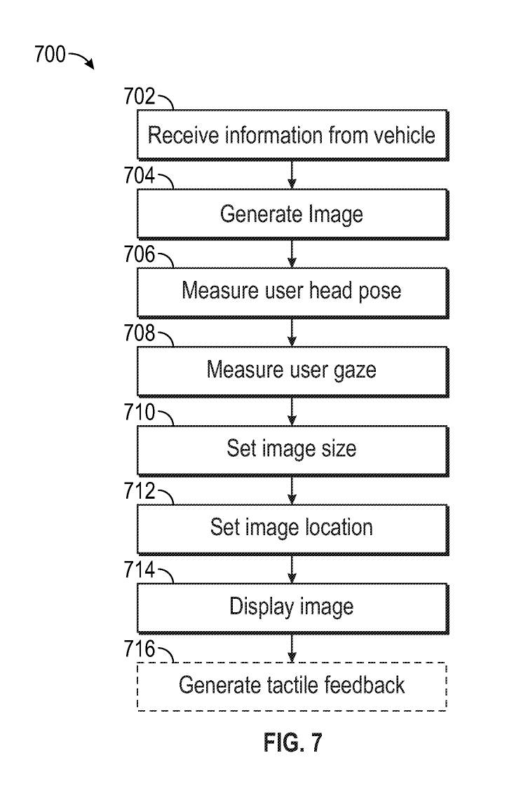

FIG. 7 illustrates an exemplary process 700 for operating AR driving glasses. Process 700 can be performed by AR driving glasses 300, 400, 500, 600, 680, or any other AR driving glasses including one or more components of system 200. Although the steps of process 700 are illustrated and described in a particular order, it should be understood that process 700 can be performed with additional or alternative steps and that one or more steps can be repeated, skipped, or performed in a different order without departing from the scope of the disclosure.

At step 702, the AR driving glasses receive information from the vehicle. The information can include information that the AR driving glasses use to generate one or more images (e.g., navigation instructions, a type and location of a hazard, vehicle information such as speed, fuel level, climate control settings, infotainment settings, etc.) or an image to be displayed (i.e., the vehicle generates the image). In some embodiments, vehicle information images are displayed such that they are positioned over the corresponding systems of the vehicle. For example, when the user changes which air vents of the climate control system are in use (e.g., upper vents, foot vents, or defrost vents), an image is displayed to superimpose arrows near the newly-activated vents. Likewise, the color of the image can correspond to a set point or a change of the set point of the climate control system. In some embodiments, the AR driving glasses can display images when the user changes settings of the vehicle's sound system. For example, when the sound balance is changed, one or more images are displayed over the location of the speakers indicating the change in balance (e.g., when the balance is moved to the right, the sound indicator images over the right speakers increase in size while the sound indicator images over the left speakers decrease in size). Information can be received via a wireless transceiver 232 or a wired connection 234 to the vehicle. In some embodiments, the AR driving glasses can additionally or alternatively receive information from a mobile device in communication with the vehicle.

At step 704, the AR driving glasses generate an image. In embodiments where the vehicle transmits an image to the AR driving glasses, generating the image includes receiving the image. Alternatively, the computer 210 of the AR driving glasses generates the image for display based on information received in step 702.

At step 706, the AR driving glasses measure the head pose (location and orientation) of the wearer. Head pose is measured based on one or more sensors 220 of the AR driving glasses, such as gyroscopes 222 and cameras 224.

At step 708, the AR driving glasses measure the gaze of the wearer. Gaze is measured with one or more cameras 224 of the AR driving glasses. The cameras 224 capture one or more images of the wearer's eyes to determine where the user is looking.

At step 710, the AR driving glasses set the image size. An image that is meant to be displayed as though it is at a particular location outside of the vehicle (e.g., navigation image 632 being displayed as though it is on the road) is sized according to the distance at which the image is supposed to appear to be located. For example, when the navigation turn is far away, the navigation image 632 is small and as the vehicle moves closer to the navigation turn, the navigation image 632 increases in size. Vehicle speed, head pose, and user gaze can also be used to determine the appropriate image size.

At step 712, the AR driving glasses set the image location. Image location is based on where the image is supposed to appear to be located (e.g., as described with reference to the navigation image 632 and warning images 634, 674, and 676), the user gaze, and the user head pose.

At step 714, the AR driving glasses display the image. The image is displayed on one or more displays 266 incorporated into the AR driving glasses lenses (e.g., lenses 260, 322, 324, 422, 424, 522, 524, 622, 624, and/or 672). The displays 266 can be controlled by the AR driving glasses' computer 210.

At step 716, the AR driving glasses optionally generate tactile feedback. The tactile feedback can be generated for one or more of the images described herein. For example, tactile feedback can be generated to notify the wearer of an upcoming navigation direction or emerging hazard (e.g., such as a nearby vehicle, pedestrian, or red light).

Thus, the disclosure above describes AR driving glasses and methods of their use.

Therefore, according to the above, some examples of the disclosure are related to an augmented-reality system having an eyewear apparatus comprising: a frame; at first lens connected to the frame, the first lens comprising a display; one or more sensors; one or more processors operatively coupled to the one or more sensors; and a memory including instructions, which when executed by the one or more processors, cause the one or more processors to perform a method comprising the steps of: generating one or more images to be displayed on the displays based at least on data from the one or more sensors. Additionally or alternatively, in some examples the first lens is located such that it is in front of the eyes of a wearer of the eyewear apparatus, the eyewear apparatus further comprises: a second lens, the second lens comprising a display, the second lens located such that it is at a periphery of an eye of the wearer of the eyewear apparatus, and a transceiver operatively coupled to a vehicle, the vehicle includes a side mirror camera, and the method performed by the processors further comprises the step of generating an image of the one or more images on the second lens based on data from the side mirror camera, the data received from the vehicle at the transceiver of the eyewear apparatus. Additionally or alternatively, in some examples the first lens has a variable focal point, the one or more sensors comprise an iris scanner, and the method further comprises the steps of: receiving, from the iris scanner, biometric data, matching the received biometric data to a stored user profile, and controlling the variable focal point of the first lens to become a stored focal point associated with the stored user profile. Additionally or alternatively, in some examples the one or more sensors comprise a gyroscope, and the method further comprises the steps of: receiving, from the gyroscope, one or more of motion and orientation data, and determining one or more of a location and size of the one or more images to be displayed in accordance with the one or more of motion and orientation data. Additionally or alternatively, in some examples the system further comprises one or more cameras directed towards eyes of a wearer of the eyewear apparatus, wherein the method further comprises the steps of: receiving, from the one or more cameras, one or more captured images including the eyes of the wearer, and determining one or more of a location and size of the one or more images to be displayed in accordance with the one or more captured images. Additionally or alternatively, in some examples the system further comprises a vibrating mechanism, wherein the method further comprises the steps of: detecting a hazard, generating one or more image notifications of the hazard, and while displaying the one or more image notifications of the hazard, causing the vibrating mechanism to vibrate. Additionally or alternatively, in some examples the system further comprises a connector cable couplable to a vehicle, the connector cable configured to receive power from the vehicle, and transmit information to and from the vehicle. Additionally or alternatively, in some examples the system further comprises a wireless transceiver, wherein the method further comprises the steps of: receiving, at the wireless transceiver, vehicle speed data from a vehicle operatively coupled to the eyewear apparatus, and determining one or more of a location and size of the one or more images to be displayed in accordance with the vehicle speed data. Additionally or alternatively, in some examples the system further comprises a wireless transceiver, wherein the method further comprises the steps of: receiving, at the wireless transceiver, vehicle settings data including an indication of a change in a vehicle setting from a vehicle operatively coupled to the eyewear apparatus, generating a vehicle settings image based on the vehicle settings data, and displaying the vehicle settings image at a location on the first lens corresponding to a component of the vehicle associated with the vehicle setting.

Some examples of the disclosure are related to a method of displaying an image on an eyewear apparatus, the method comprising: receiving data from one or more sensors included in the eyewear apparatus; and generating an image for display on a display included in a first lens included in the eyewear apparatus, the images generated based on at least the data from the one or more sensors. Additionally or alternatively, in some examples the first lens is located such that it is in front of the eyes of a wearer of the eyewear apparatus, the eyewear apparatus further comprises: a second lens, the second lens comprising a display, the second lens located such that it is at a periphery of an eye of the wearer of the eyewear apparatus, and a transceiver operatively coupled to a vehicle, the vehicle includes a side mirror camera, and the method further comprises the step of generating an image of the one or more images on the second lens based on data from the side mirror camera, the data received from the vehicle at the transceiver of the eyewear apparatus. Additionally or alternatively, in some examples the one or more sensors comprise a gyroscope, and the method further comprises the steps of: receiving, from the gyroscope, one or more of motion and orientation data, and determining one or more of a location and size of the one or more images to be displayed in accordance with the one or more of motion and orientation data. Additionally or alternatively, in some examples the eyewear apparatus further includes one or more cameras directed towards eyes of a wearer of the eyewear apparatus, and the method further comprises the steps of: receiving, from the one or more cameras, one or more captured images including the eyes of the wearer, and determining one or more of a location and size of the one or more images to be displayed in accordance with the one or more captured images. Additionally or alternatively, in some examples the eyewear apparatus further comprises a vibrating mechanism, and the method further comprises the steps of: detecting a hazard, generating one or more image notifications of the hazard, and while displaying the one or more image notifications of the hazard, causing the vibrating mechanism to vibrate. Additionally or alternatively, in some examples the eyewear apparatus further comprises a wireless transceiver, and the method further comprises the steps of: receiving, at the wireless transceiver, vehicle speed data from a vehicle operatively coupled to the eyewear apparatus, and determining one or more of a location and size of the one or more images to be displayed in accordance with the vehicle speed data. Additionally or alternatively, in some examples the eyewear apparatus further comprises a wireless transceiver, and the method further comprises the steps of: receiving, at the wireless transceiver, vehicle settings data including an indication of a change in a vehicle setting from a vehicle operatively coupled to the eyewear apparatus, generating a vehicle settings image based on the vehicle settings data, and displaying the vehicle settings image at a location on the first lens corresponding to a component of the vehicle associated with the vehicle setting.

Some examples of the disclosure are related to a non-transitory computer-readable medium including instructions, which when executed by one or more processors of an eyewear apparatus, cause the one or more processors to perform a method comprising: receiving data from one or more sensors included in the eyewear apparatus; and generating an image for display on a display included in a first lens included in the eyewear apparatus, the images generated based on at least the data from the one or more sensors. Additionally or alternatively, in some examples the first lens is located such that it is in front of the eyes of a wearer of the eyewear apparatus, the eyewear apparatus further comprises: a second lens, the second lens comprising a display, the second lens located such that it is at a periphery of an eye of the wearer of the eyewear apparatus, and a transceiver operatively coupled to a vehicle, the vehicle includes a side mirror camera, and the method further comprises the step of generating an image of the one or more images on the second lens based on data from the side mirror camera, the data received from the vehicle at the transceiver of the eyewear apparatus. Additionally or alternatively, in some examples the eyewear apparatus further comprises a wireless transceiver, and the method further comprises the steps of: receiving, at the wireless transceiver, vehicle speed data from a vehicle operatively coupled to the eyewear apparatus, and determining one or more of a location and size of the one or more images to be displayed in accordance with the vehicle speed data. Additionally or alternatively, in some examples the eyewear apparatus further comprises a wireless transceiver, and the method further comprises the steps of: receiving, at the wireless transceiver, vehicle settings data including an indication of a change in a vehicle setting from a vehicle operatively coupled to the eyewear apparatus, generating a vehicle settings image based on the vehicle settings data, and displaying the vehicle settings image at a location on the first lens corresponding to a component of the vehicle associated with the vehicle setting.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

What is claimed is:

1. An augmented-reality system having an eyewear apparatus comprising:
a frame;
at first lens connected to the frame, the first lens comprising a display;
one or more sensors;
one or more processors operatively coupled to the one or more sensors; and
a memory including instructions, which when executed by the one or more processors, cause the one or more processors to perform a method comprising the steps of:
generating one or more images to be displayed on the displays based at least on data from the one or more sensors.

2. The system of claim 1, wherein:
the first lens is located such that it is in front of the eyes of a wearer of the eyewear apparatus,
the eyewear apparatus further comprises:
a second lens, the second lens comprising a display, the second lens located such that it is at a periphery of an eye of the wearer of the eyewear apparatus, and
a transceiver operatively coupled to a vehicle,
the vehicle includes a side mirror camera, and
the method performed by the processors further comprises the step of generating an image of the one or more images on the second lens based on data from the side mirror camera, the data received from the vehicle at the transceiver of the eyewear apparatus.

3. The system of claim 1, wherein:
the first lens has a variable focal point,
the one or more sensors comprise an iris scanner, and
the method further comprises the steps of:
receiving, from the iris scanner, biometric data,
matching the received biometric data to a stored user profile, and
controlling the variable focal point of the first lens to become a stored focal point associated with the stored user profile.

4. The system of claim 1, wherein:
the one or more sensors comprise a gyroscope, and
the method further comprises the steps of:
receiving, from the gyroscope, one or more of motion and orientation data, and
determining one or more of a location and size of the one or more images to be displayed in accordance with the one or more of motion and orientation data.

5. The system of claim 1, further comprising:
one or more cameras directed towards eyes of a wearer of the eyewear apparatus, wherein the method further comprises the steps of:
receiving, from the one or more cameras, one or more captured images including the eyes of the wearer, and
determining one or more of a location and size of the one or more images to be displayed in accordance with the one or more captured images.

6. The system of claim 1, further comprising:
a vibrating mechanism, wherein the method further comprises the steps of:
detecting a hazard,
generating one or more image notifications of the hazard, and
while displaying the one or more image notifications of the hazard, causing the vibrating mechanism to vibrate.

7. The system of claim 1, further comprising:
a connector cable couplable to a vehicle, the connector cable configured to receive power from the vehicle, and transmit information to and from the vehicle.

8. The system of claim 1, further comprising:
a wireless transceiver, wherein the method further comprises the steps of:
receiving, at the wireless transceiver, vehicle speed data from a vehicle operatively coupled to the eyewear apparatus, and
determining one or more of a location and size of the one or more images to be displayed in accordance with the vehicle speed data.

9. The system of claim 1, further comprising:
a wireless transceiver, wherein the method further comprises the steps of:
receiving, at the wireless transceiver, vehicle settings data including an indication of a change in a vehicle setting from a vehicle operatively coupled to the eyewear apparatus,
generating a vehicle settings image based on the vehicle settings data, and
displaying the vehicle settings image at a location on the first lens corresponding to a component of the vehicle associated with the vehicle setting.

10. A method of displaying an image on an eyewear apparatus, the method comprising:
receiving data from one or more sensors included in the eyewear apparatus; and
generating an image for display on a display included in a first lens included in the eyewear apparatus, the images generated based on at least the data from the one or more sensors.

11. The method of claim 10, wherein:
the first lens is located such that it is in front of the eyes of a wearer of the eyewear apparatus,
the eyewear apparatus further comprises:
a second lens, the second lens comprising a display, the second lens located such that it is at a periphery of an eye of the wearer of the eyewear apparatus, and
a transceiver operatively coupled to a vehicle,
the vehicle includes a side mirror camera, and
the method further comprises the step of generating an image of the one or more images on the second lens based on data from the side mirror camera, the data received from the vehicle at the transceiver of the eyewear apparatus.

12. The method of claim 10, wherein:
the one or more sensors comprise a gyroscope, and
the method further comprises the steps of:
receiving, from the gyroscope, one or more of motion and orientation data, and
determining one or more of a location and size of the one or more images to be displayed in accordance with the one or more of motion and orientation data.

13. The method of claim 10, wherein:
the eyewear apparatus further includes one or more cameras directed towards eyes of a wearer of the eyewear apparatus, and
the method further comprises the steps of:
receiving, from the one or more cameras, one or more captured images including the eyes of the wearer, and
determining one or more of a location and size of the one or more images to be displayed in accordance with the one or more captured images.

14. The method of claim 10, wherein:
the eyewear apparatus further comprises a vibrating mechanism, and
the method further comprises the steps of:
detecting a hazard,
generating one or more image notifications of the hazard, and
while displaying the one or more image notifications of the hazard, causing the vibrating mechanism to vibrate.

15. The method of claim 10, wherein:
the eyewear apparatus further comprises a wireless transceiver, and
the method further comprises the steps of:
receiving, at the wireless transceiver, vehicle speed data from a vehicle operatively coupled to the eyewear apparatus, and
determining one or more of a location and size of the one or more images to be displayed in accordance with the vehicle speed data.

16. The method of claim 10, wherein:
the eyewear apparatus further comprises a wireless transceiver, and
the method further comprises the steps of:
receiving, at the wireless transceiver, vehicle settings data including an indication of a change in a vehicle setting from a vehicle operatively coupled to the eyewear apparatus,
generating a vehicle settings image based on the vehicle settings data, and
displaying the vehicle settings image at a location on the first lens corresponding to a component of the vehicle associated with the vehicle setting.

17. A non-transitory computer-readable medium including instructions, which when executed by one or more processors of an eyewear apparatus, cause the one or more processors to perform a method comprising:
receiving data from one or more sensors included in the eyewear apparatus; and
generating an image for display on a display included in a first lens included in the eyewear apparatus, the images generated based on at least the data from the one or more sensors.

18. The non-transitory computer-readable medium of claim 17, wherein:
the first lens is located such that it is in front of the eyes of a wearer of the eyewear apparatus,
the eyewear apparatus further comprises:
a second lens, the second lens comprising a display, the second lens located such that it is at a periphery of an eye of the wearer of the eyewear apparatus, and
a transceiver operatively coupled to a vehicle,
the vehicle includes a side mirror camera, and
the method further comprises the step of generating an image of the one or more images on the second lens based on data from the side mirror camera, the data received from the vehicle at the transceiver of the eyewear apparatus.

19. The non-transitory computer-readable medium of claim 17, wherein:
the eyewear apparatus further comprises a wireless transceiver, and
the method further comprises the steps of:
receiving, at the wireless transceiver, vehicle speed data from a vehicle operatively coupled to the eyewear apparatus, and
determining one or more of a location and size of the one or more images to be displayed in accordance with the vehicle speed data.

20. The non-transitory computer-readable medium of claim 17, wherein:
the eyewear apparatus further comprises a wireless transceiver, and
the method further comprises the steps of:
receiving, at the wireless transceiver, vehicle settings data including an indication of a change in a vehicle setting from a vehicle operatively coupled to the eyewear apparatus,
generating a vehicle settings image based on the vehicle settings data, and
displaying the vehicle settings image at a location on the first lens corresponding to a component of the vehicle associated with the vehicle setting.
